(19) United States
(12) Patent Application Publication
(10) Pub. No.: US 2014/0344352 A1
(43) Pub. Date: Nov. 20, 2014

(54) ACTIVITY INTERNET-ACCESSIBLE DATA STORAGE VIEW THAT SHOWS RECENT AND RELEVANT CONTENT TO THE USER

(71) Applicant: Microsoft Corporation, Redmond, WA (US)

(72) Inventors: Deepesh Mohnani, Seattle, WA (US); Greg Edmiston, Seattle, WA (US); Sarah Filman, Seattle, WA (US); Seung-Hae Park, Seattle, WA (US); Mona Akmal, Kirkland, WA (US); Amanda Font, Kirkland, WA (US); Patricia Hendricks, Seattle, WA (US)

(73) Assignee: Microsoft Corporation, Redmond, WA (US)

(21) Appl. No.: 13/896,327

(22) Filed: May 17, 2013

(51) Int. Cl. H04L 29/08

(52) U.S. Cl. CPC H04L 67/26
USPC 709/204

(57) ABSTRACT

In one embodiment, an internet-accessible resource service may emphasize a recently accessed data object stored in an internet-accessible data storage 124 on a data object list 300. The internet-accessible resource service may maintain a data object list 300 representing a data object set stored in an internet-accessible data storage 124 accessible by a primary user. The internet-accessible resource service may detect an access of a user-focus data object of the data object set. The internet-accessible resource service may execute a reorganization of the data object list 300 to emphasize the user-focus data object.

### BACKGROUND

A user may create a user account with an internet-accessible resource service, such as a cloud service. An internet-accessible resource service interacts with a thin client resident on a user device, outsourcing a computer service to one or more computing devices distributed in a network, referred to as the cloud. An internet-accessible resource service may provide an internet-accessible resource, such as data storage, processing, an application, or other computing services, to a user across multiple user devices. A user may share an internet-accessible resource with other user accounts for the internet-accessible resource service.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to emphasizing a recently accessed data object stored in an internet-accessible data storage on a data object list. The internet-accessible resource service may maintain a data object list representing a data object set stored in an internet-accessible data storage accessible by a primary user. The internet-accessible resource service may detect an access of a user-focus data object of the data object set. The internet-accessible resource service may execute a reorganization of the data object list to emphasize the user-focus data object.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a resource network.

FIG. 2 illustrates, in a block diagram, one embodiment of a computing device.

FIG. 3 illustrates, in a block diagram, one embodiment of a data object list associated with a primary user.

FIG. 4 illustrates, in a flowchart, one embodiment of a method of creating a data object list view at the resource server.

FIG. 5 illustrates, in a flowchart, one embodiment of a method of alerting a user to a reorganization of a data object list.

FIG. 6 illustrates, in a flowchart, one embodiment of a method of creating a data object list view at the primary user device.

FIG. 7 illustrates, in a flowchart, one embodiment of a method of determining a user-focus data object.

FIG. 8 illustrates, in a flowchart, one embodiment of a method of organizing a data object list.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or an internet-accessible data storage manager.

An internet-accessible data storage manager may present a view to a user on a user device displaying a list of data objects stored in an internet-accessible data storage by the user. A data object is a folder or a data file. A user device or a resource server may act as an internet-accessible data storage manager. The internet-accessible data storage manager may move the data object up the list upon an access of the data object, by the primary user or other users, to emphasize the data object to the user. An access is a read action, copy action, edit action, move action, create action, delete action, or share action directed towards the data object. A user may share, view, edit, move, or perform other actions on a data object stored in the internet-accessible data storage. Previously, a data object list presented by the internet-accessible resource service may be a static list that a user may modify to organize by date modified, date added, and other criteria. The internet-accessible data storage manager may automatically reorganize the data object list based on actions of a primary user and of any other users that the primary user has shared a data object on the list. The internet-accessible data storage manager may associate the data object list with a primary user and annotate a data object on the data object list with an access annotation, describing an access of the data object and the user performing the access. When multiple accesses have occurred on a single data object, the access annotations may be aggregated into a single aggregation for brevity. The internet-accessible resource data storage manager may notify the user when the data object list has been reorganized using a push notification.

Thus, in one embodiment, an internet-accessible resource service may emphasize a recently accessed data object stored in an internet-accessible data storage on a data object list. The internet-accessible resource service may maintain a data object list representing a data object set stored in an internet-accessible data storage accessible by a primary user. The internet-accessible resource service may detect an access of a user-focus data object of the data object set, such as a folder or file, by a sharing user or by the primary user. The internet-accessible resource service may execute a reorganization of the data object list to emphasize the user-focus data object. The internet-accessible resource server may send a push notification to the primary user to alert of an access of the user-focus data object.

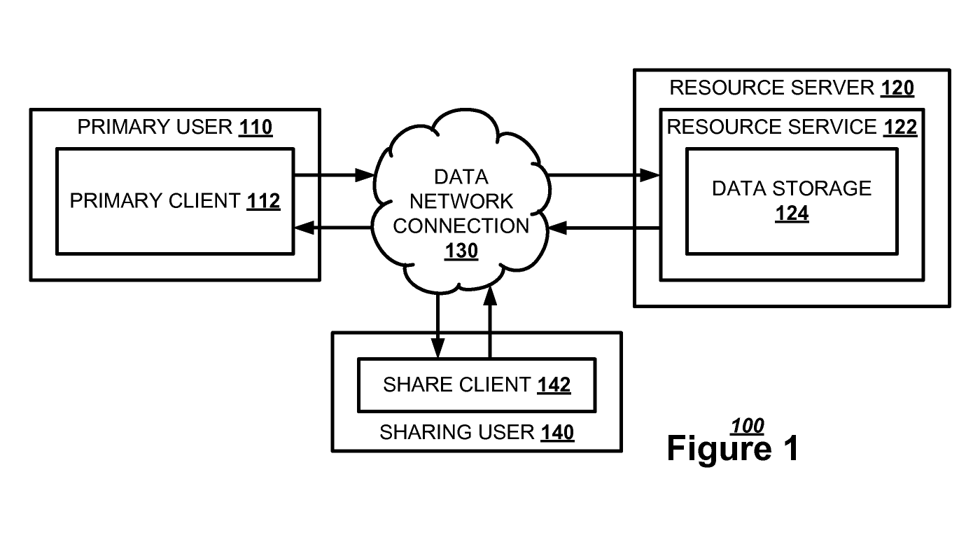

FIG. 1 illustrates, in a block diagram, one embodiment of a resource network 100. A primary user device 110 may execute a primary client 112 that connects to one or more resource servers 120 executing an internet-accessible resource service 122 via a data network connection 130. The data network connection 130 may be an internet connection, a wide area network connection, a local area network connection, or other type of data network connections. The primary client 112 may be a thin client application native to the primary user device 110 or a web application resident in a browser platform. The primary client 112 may access the internet-accessible resource service 122 using a primary user account of the internet-accessible resource service 122. The internet-accessible resource service 122 may manage one or more internet-accessible resources, such as an internet-accessible data storage 124. The internet-accessible resource service 122 may allocate the internet-accessible data storage 124 to the primary user account.

A sharing user device 140 may execute a sharing client 142 that accesses the internet-accessible resource service 122 using a sharing user account of the internet-accessible resource service 122. The sharing client 142 may be a thin client application native to the sharing user device 140 or a web application resident in a browser platform. The primary user account may share access to data objects stored in the internet-accessible data storage 124 by the primary user with the sharing user account. Alternately, the sharing user account may share access to data objects stored in the internet-accessible data storage 124 by the sharing user with the primary user account. By sharing access, the sharing user account may access a data file stored in the internet-accessible data storage 124 to edit, copy, move, or erase the data file. Additionally, the sharing user account may access a shared folder stored in the internet-accessible data storage 124 to edit, copy, move, or erase data files stored in the folder, as well as add new data files to the folder.

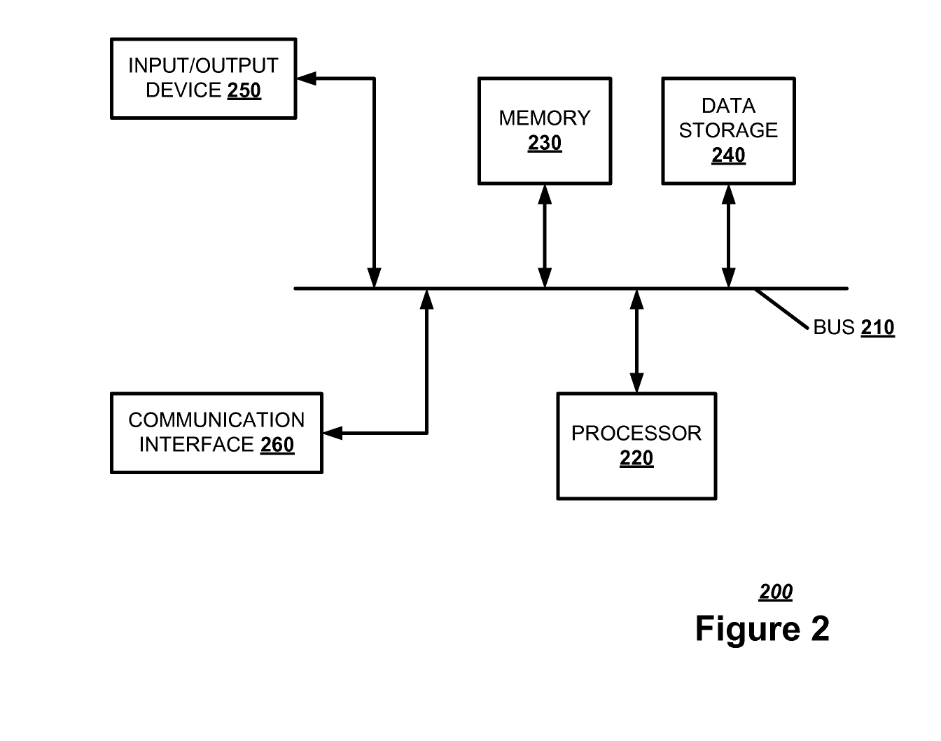

FIG. 2 illustrates a block diagram of an exemplary computing device 200 which may act as a primary user device 110, a sharing user device 140, or a resource server 120. The computing device 200 may combine one or more of hardware, software, firmware, and system-on-a-chip technology to implement a primary user device 110, a sharing user device 140, or a resource server 120. The computing device 200 may include a bus 210, a processor 220, a memory 230, a data storage 240, an input/output device 250, and a communication interface 260. The bus 210, or other component interconnection, may permit communication among the components of the computing device 200.

The processor 220 may include at least one conventional processor or microprocessor that interprets and executes a set of instructions. The memory 230 may be a random access memory (RAM) or another type of dynamic data storage that stores information and instructions for execution by the processor 220. The memory 230 may also store temporary variables or other intermediate information used during execution of instructions by the processor 220. The data storage 240 may include a conventional ROM device or another type of static data storage that stores static information and instructions for the processor 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing a data object list or a data object set.

The input/output device 250 may include one or more conventional mechanisms that permit a user to input information to the computing device 200, such as a keyboard, a mouse, a voice recognition device, a microphone, a headset, a gesture recognition device, a touch screen, etc. The input/output device 250 may include one or more conventional mechanisms that output information to the user, including a display, a printer, one or more speakers, a headset, or a medium, such as a memory, or a magnetic or optical disk and a corresponding disk drive. The communication interface 260 may include any transceiver-like mechanism that enables computing device 200 to communicate with other devices or networks. The communication interface 260 may include a network interface or a transceiver interface. The communication interface 260 may be a wireless, wired, or optical interface.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

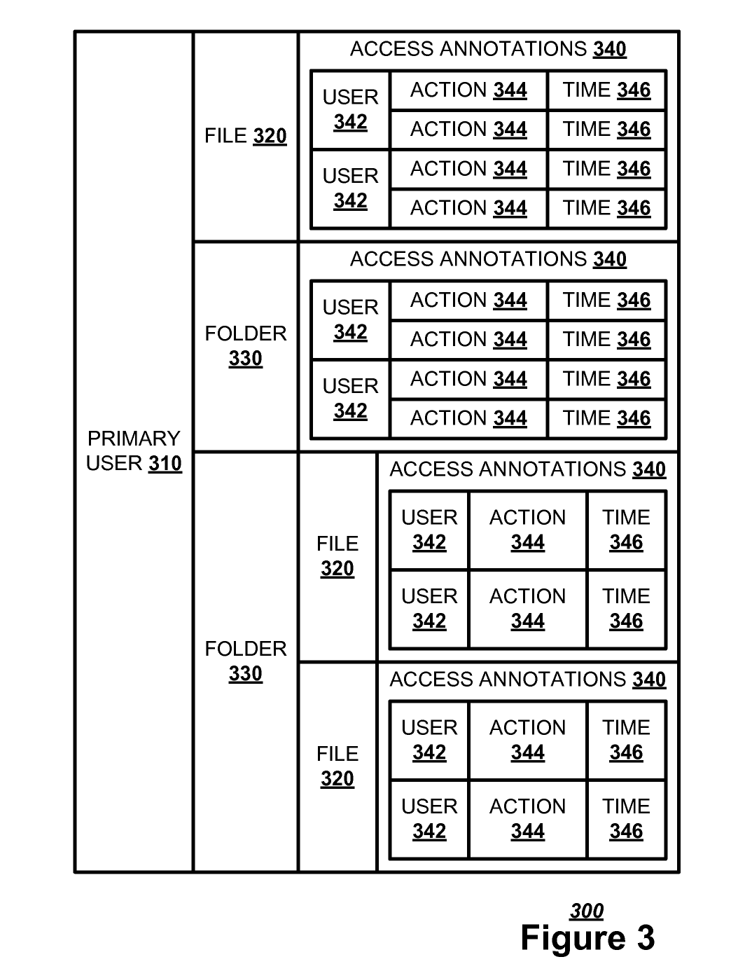

FIG. 3 illustrates, in a block diagram, one embodiment of a data object list 300. The data object list 300 may describe one or more data objects associated with a primary user 310 in an internet-accessible data storage 124. The data object list 300 may be compiled, stored, or reorganized at the user device 110, the resource server 120, or both. A data object may be a data file 320 or a folder 330. The data file 320 may be stored in a folder 330 or stored separately in the internet-accessible data storage 124. The data object list 300 may associate aggregated access annotations 340 with either the data file 320 or the folder 330. An access annotation 340 may describe a user 342 accessing the data object , the accessing action 344 that the user 342 performed on that data object, and the timestamp 346 when the accessing action occurred. An accessing action 344 may be a read, a copy, an edit, a create, a move, a delete, a share, a rename, an embed, a restore, or other data action. For example, an access annotation 340 may state: “Bob added Baby.jpg to the Family Photos folder at 03:44 pm on Mar. 1, 2013.” If multiple users have accessed a data object, the access annotation 340 for each access action 344 may be aggregated in to a single access annotation 340. For example, an aggregated access annotation 340 may state: “5 people have accessed the Family Photos folder.” The user may select the aggregated access annotation 340 to expand the aggregated access annotation 340 to display each access action 344 and timestamp 346 for each user 342. The data object list 300 may aggregate annotations at the data file 320 or folder 330 level, as directed by the primary user 310.

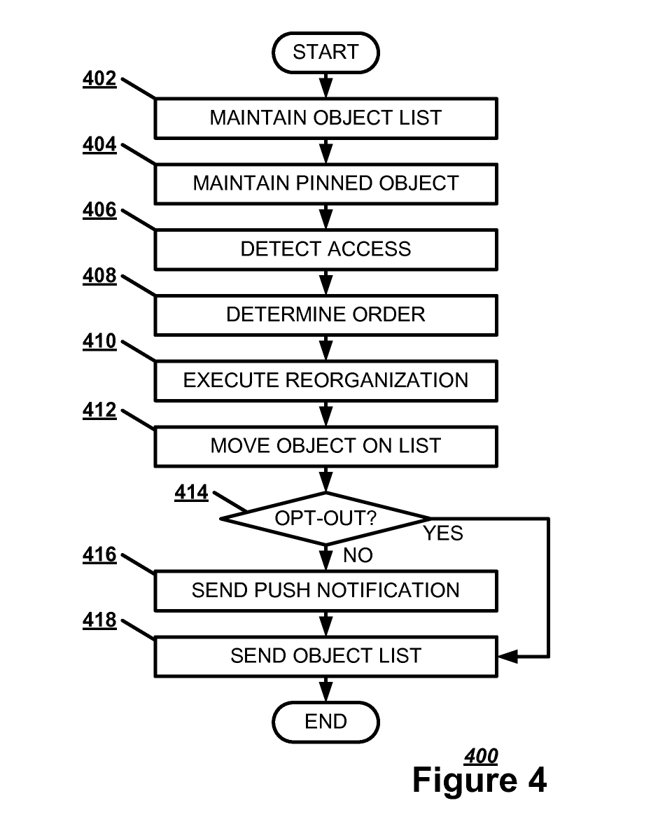

The data object list 300 may be maintained and organized at either the resource server 120 or at the primary user device 110. FIG. 4 illustrates, in a flowchart, one embodiment of a method 400 of creating a data object list view at the resource server 120. The resource server 120 may maintain a data object list 300 representing a data object set stored in an internet-accessible data storage 124 accessible by a primary user 310 (Block 402). The resource server 120 may maintain a pinned data object upon identification by the primary user 310 (Block 404). A pinned data object may maintain a static position in the data object list 300 at the request of the user. The resource server 120 may detect an access of a user-focus data object on the data object list 300 (Block 406). A user-focus data object is a data file 320 or folder 330 that a user has indicated at least a minimal interest in monitoring. The minimal interest may be creating the data object or having accessed the data object upon receiving from a sharing user. For example, the resource server 120 may detect an access of a primary user 310 created folder 330 of the data object set by a sharing user.

The resource server 120 may determine a reorganization order based on an access type (Block 408). An access type may be a read, an edit, a move, a create, or a delete. The resource server 120 may execute the reorganization of the data object list 300 to emphasize the user-focus data object (Block 410). The resource server 120 may move the user-focus data object on the data object list 300 upon an access of the user-focus data object (Block 412). If the resource server 120 has not received a notification opt-out from the primary user (Block 414), the resource server 120 may send a push notification to the primary user 310 to alert of the access (Block 416). The notification opt-out may specify that the primary user does not want to receive push notifications about accesses to a specific data object or accesses by a specific user. The resource server 120 may send the data object list 300 to a primary user device 110 for display after the reorganization (Block 418).

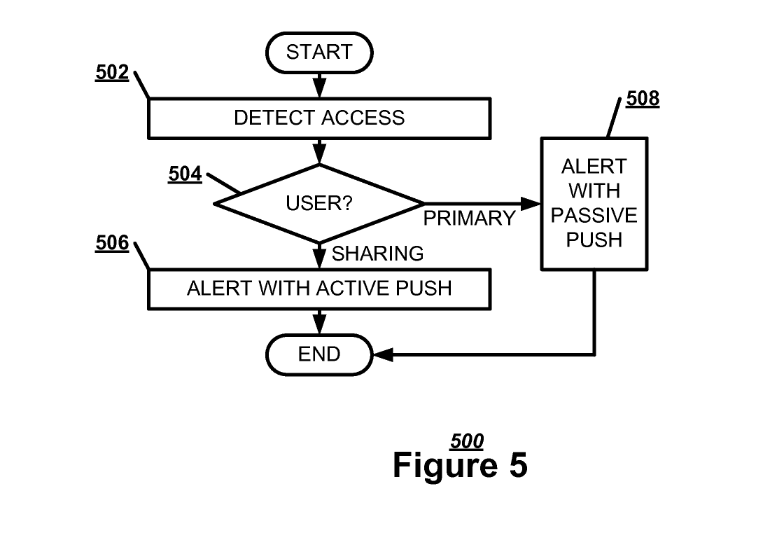

FIG. 5 illustrates, in a flowchart, one embodiment of a method 600 of alerting a user to a reorganization of a data object list 300. The resource server 120 may detect an access of a user-focus data object on the data object list 300 (Block 502). If the resource server 120 detects that the access of the user-focus data object is by a sharing user (Block 504), the resource server 120 may alert the primary user 310 to the access with an active push notification (Block 506). An active push notification is a notification sent by the resource server 120 to a user device in a manner that interrupts a current process of the user device, such as an e-mail, a short message service, a pop-up notification, or a toast window. If the resource server 120 detects that the access of the user-focus data object is by a primary user 310 (Block 504), the resource server 120 may alert the primary user 310 to the access with a passive push notification (Block 508). A passive push notification is a notification sent by the resource server 120 to a user device in a manner that does not interrupt a current process of the user device, such as a message on an interactive application launch tile.

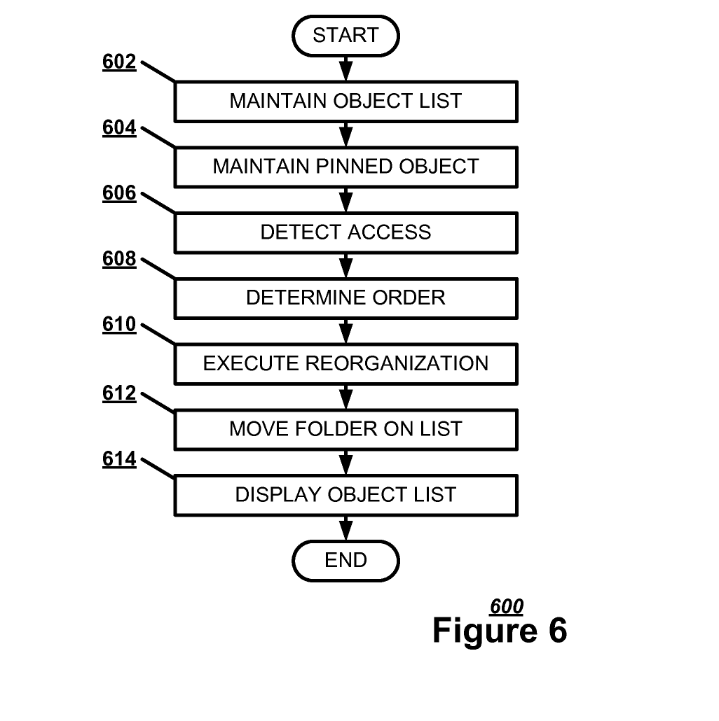

FIG. 6 illustrates, in a flowchart, one embodiment of a method 600 of maintaining a data object list view at the primary user device 110. The primary user device 110 may maintain a data object list 300 representing a data object set stored in an internet-accessible data storage 124 accessible by a primary user 310 (Block 602). The primary user device 110 may maintain a pinned data object upon identification by the primary user 310 (Block 604). The primary user device 110 may detect an access of a user-focus data object on the data object list 300. For example, the primary user device 110 may detect an access of a user-focus folder 330 of the data object by a sharing user (Block 606). The primary user device 110 may detect the access by the resource server 120 sending a notice of the access.

The primary user device 110 may determine a reorganization order based on an access type (Block 608). The primary user device 110 may execute the reorganization of the data object list 300 to emphasize the user-focus data object (Block 610). The primary user device 110 may move the user-focus data object, such as moving a user-focus folder 330, on the data object list 300 upon a folder access (Block 612). The primary user device 110 may display the data object list 300 upon the reorganization (Block 614).

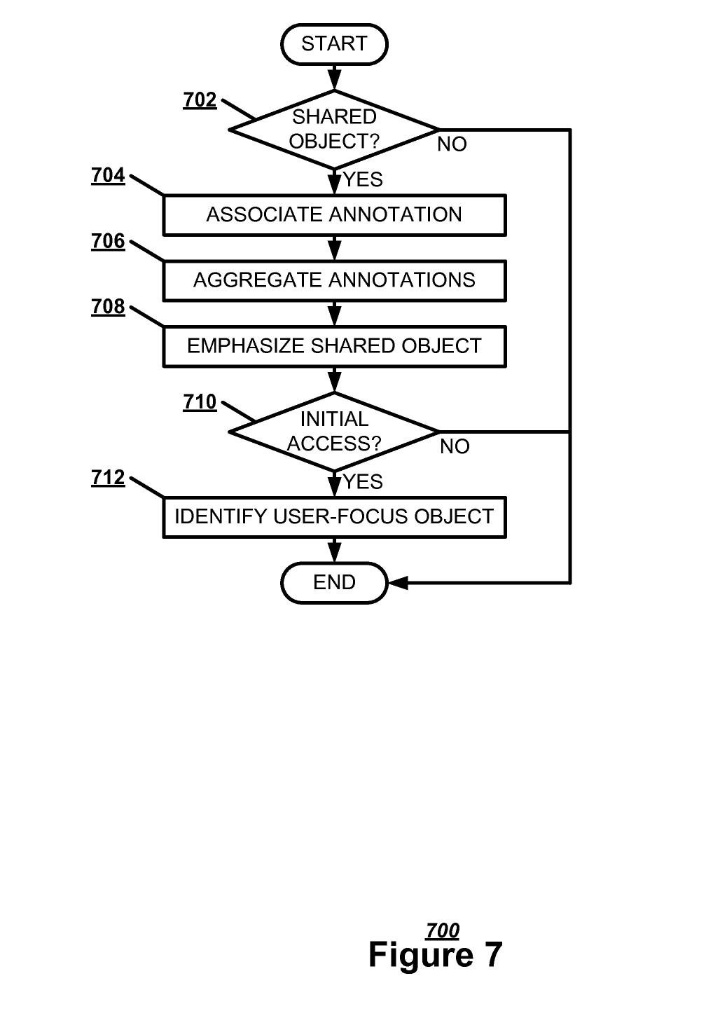

FIG. 7 illustrates, in a flowchart, one embodiment of a method 500 of determining a user-focus data object. If the primary user 310 receives a shared data object for the data object set from a sharing user (Block 702), the resource server 120 or the primary user device 110 may associate an access annotation 340 with the shared data object (Block 704). The access annotation 340 may describe to the primary user 310 that the sharing user has shared the shared data object. If previous accesses have occurred with the shared data object, the resource server 120 or the primary user device 110 may aggregate multiple access annotations 340 to the shared data object (Block 706). The resource server 120 or the primary user device 110 may emphasize the shared data object in the data object list 300 by moving the user-focus data object on the data object list 300 (Block 708). If the primary user 310 executes an initial access of the shared data object (Block 710), the resource server 120 or the primary user device 110 may identify the shared data object as a user-focus data object (Block 712).

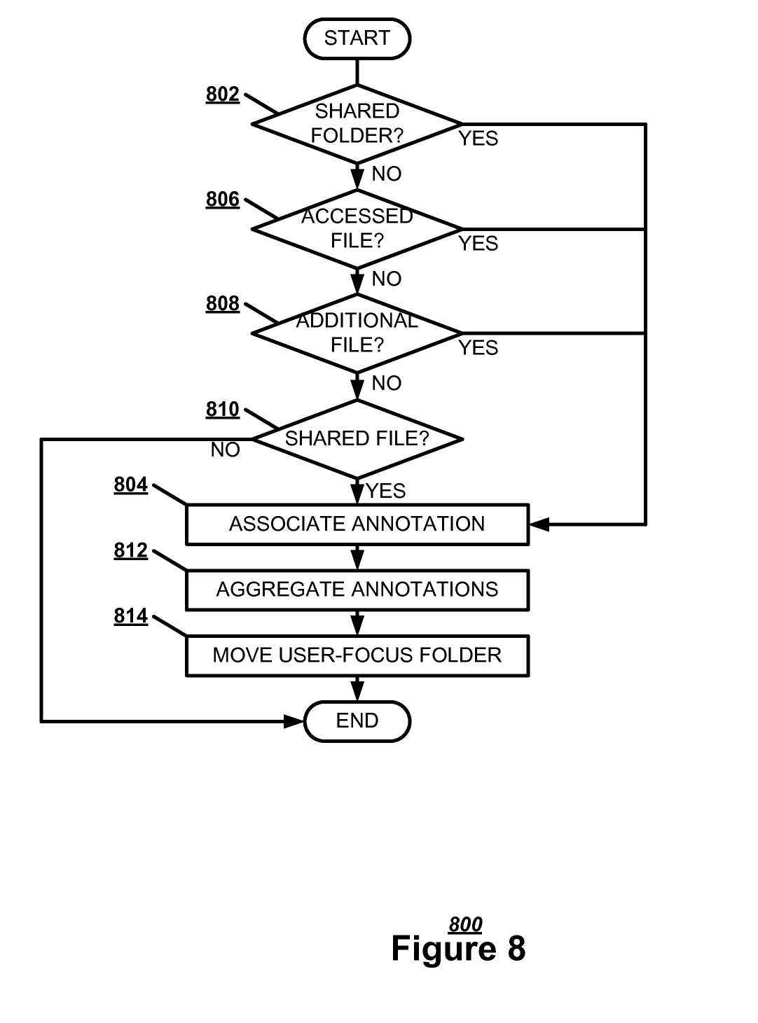

FIG. 8 illustrates, in a flowchart, one embodiment of a method 800 of organizing a data object list 300. If the primary user 310 receives a shared folder 330 for the data object set from the sharing user (Block 802), the resource server 120 or the primary user device 110 may associate an access annotation 340 with the shared folder 330 (Block 804). If the primary user 310 detects an accessed data file 320 in the user-focus folder 330 (Block 806), the resource server 120 or the primary user device 110 may associate an access annotation 340 with the accessed data file 320 or the user-focus folder 330 (Block 804). If the primary user 310 detects an additional data file 320 added to the user-focus folder 330 (Block 808), the resource server 120 or the primary user device 110 may associate an access annotation 340 with the additional data file 320 or the user-focus folder 330 (Block 804). If the primary user 310 receives a shared data file 320 in the user-focus folder 330 for the data object set from the sharing user (Block 810), the resource server 120 or the primary user device 110 may associate an access annotation 340 with the shared data file 320 or the user-focus folder 330 (Block 804). The resource server 120 or the primary user device 110 may aggregate multiple access annotations to the user-focus folder 330 or the user focus data file 320 (Block 812). The resource server 120 or the primary user device 110 may move the user-focus folder up the data object list 300 upon a folder access (Block 814).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
maintaining a data object list representing a data object set stored in an internet-accessible data storage accessible by a primary user;
detecting an access of a user-focus data object on the data object list;
executing a reorganization of the data object list to emphasize the user-focus data object; and
sending a push notification to the primary user to alert of the access.

2. The method of claim 1, further comprising:
detecting the access of the user-focus data object by a sharing user.

3. The method of claim 2, further comprising:
alerting the primary user to the access with an active push notification.

4. The method of claim 1, further comprising:
detecting the access of the user-focus data object by the primary user.

5. The method of claim 4, further comprising:
alerting the primary user to the access with a passive push notification.

6. The method of claim 1, further comprising:
moving the user-focus data object on the data object list upon an access of the user-focus data object.

7. The method of claim 1, further comprising:
receiving a shared data object for the data object set from a sharing user.

8. The method of claim 1, further comprising:
emphasizing the shared data object in the data object list.

9. The method of claim 1, further comprising:
identifying the user-focus data object upon an initial access by the primary user.

10. The method of claim 1, further comprising:
maintain a pinned data object upon identification by the primary user.

11. The method of claim 1, further comprising:
determine a reorganization order based on an access type.

12. The method of claim 1, further comprising:
receiving a notification opt-out from the primary user.

13. A tangible machine-readable medium having a set of instructions detailing a method stored thereon that when executed by one or more processors cause the one or more processors to perform the method, the method comprising:
maintaining a data object list representing a data object set stored in an internet-accessible data storage accessible by a primary user;
detecting an access of a user-focus folder of the data object set by a sharing user;
executing a reorganization of the data object list to emphasize the user-focus folder; and
moving the user-focus folder on the data object list upon a folder access.

14. The tangible machine-readable medium of claim 13, wherein the method further comprises:
detecting an additional data file added to the user-focus folder.

15. The tangible machine-readable medium of claim 13, wherein the method further comprises:
detecting an accessed data file in the user-focus folder.

16. The tangible machine-readable medium of claim 13, wherein the method further comprises:
receiving a shared folder for the data object set from the sharing user.

17. The tangible machine-readable medium of claim 13, wherein the method further comprises:
receiving a shared data file in the user-focus folder for the data object set from the sharing user.

18. The tangible machine-readable medium of claim 13, wherein the method further comprises:
displaying the data object list upon a reorganization.

19. An internet-accessible data storage manager, comprising:
a memory that stores a data object list representing a data object set stored in an internet-accessible data storage by a primary user;
a processor that detects a user-focus data object on the data object list, executes a reorganization of the data object list to emphasize the user-focus data object, and associates an access annotation with the user-focus data object.

20. The internet-accessible data storage manager of claim 19, wherein the processor may aggregate multiple access annotations to the user-focus data object.
